(19) United States
(12) Patent Application Publication
(10) Pub. No.: US 2019/0114948 A1
(43) Pub. Date: Apr. 18, 2019

(54) Panel For An Electronic Device And Process

(71) Applicant: Henkel AG & Co. KGaA, Duesseldorf (DE)

(72) Inventors: Robert Ruiz Hernandez, Duesseldorf (DE); Alexander Gruber, Berlin (DE)

(73) Assignee: Henkel AG & Co. KGaA, Duesseldorf (DE)

(21) Appl. No.: 16/218,712

(22) Filed: Dec. 13, 2018

Related U.S. Application Data
(63) Continuation of application No. PCT/EP2017/064460, filed on Jun. 13, 2017.

(30) Foreign Application Priority Data
Jun. 15, 2016 (EP) 16174663

(51) Int. Cl. G09F 9/302; G09F 13/04; G09F 13/22

(52) U.S. Cl. CPC G09F 9/3023; G09F 13/04; H01H 13/023; G09F 2013/0427; G09F 2013/222; G09F 13/22

(57) ABSTRACT

A panel for an electronic device, with a front side, and a back side. The panel including a sign, suitable to be viewed from the panel's front side, wherein the sign has an annular shape. The sign has 3 indicia mit light, each being an annular segment of the annular shape, each with an angular length, and further each two adjacent indicia mechanisms are spaced by an angular gap alpha, and wherein 0°<=alpha is <=20°.

### FIELD OF THE INVENTION

The present invention describes a panel for an electronic device and a process for transferring the data represented by the panel to a computer.

### BACKGROUND OF THE INVENTION

Electronic devices, especially devices for use at home, commonly have indicia means for transmitting the information of the status of the device to a user. A light emitting diode (LED) is used frequently to show if a device is powered on. Other times as matrix display is used onto which all kinds of graphical symbols can be shown, including text information.

For some devices, a matrix display may not be adequate, for many reasons, e.g. contrast, space or cost. Such devices sometimes have a few LED, each one representing a different status. However, a user still may have difficulty to interpret the status of the device, because it has to, each time, check on the label of the device itself, or on a manual, what the current indicia means. Further, the use of buttons in addition to the indicia is difficult to place in the device's panel, and occupies a lot of the panel's surface.

U.S. Pat. No. 6,420,970 B1 discloses an emergency door opening system with a housing and an emergency door opening button. In order to facilitate the rapid localization of the emergency door system, the emergency door operation button is illuminated but does not emit light. Light emitting elements are luminous elements, which are arranged in a circle, e.g., in the form of light-emitting diodes, in the housing. Some of the nine luminous elements can be emit green light and some red light.

Document EP 1 389 788 A1 discloses a function indicator for visually indicating an operating state of equipment. The function indicator may be realized with a push button switch surrounded by a light ring, wherein the light ring may appear dark or illuminated to indicate that a TV is in standby or on.

Document JP 2014 044375 A discloses a configuration with improved <design characteristics in an illumination cover member arranged on an air conditioner operation part, a shift lever operation part or the like, of an automobile, and capable of making an illumination part emit light by illumination from its rear side. The sign comprises different text information labels arranged on an upper circular segment above a central switch, which text labels can show the status “ON”, “OFF” or “ACC”.

### BRIEF SUMMARY OF THE INVENTION

The present invention aims to solve the above problems, by providing a panel for an electronic device. The dependent claims refer to further preferred developments of the invention. The invention also refers to a process using the inventive panel.

The present invention concerns a panel for an electronic device, with a front side, and a back side. The panel comprises a sign, suitable to be viewed from its front side. The sign has an annular shape and the sign has 3 indicia means. Each indicia means is an annular segment of the annular shape, each with an angular length (β). Each of the two adjacent indicia means are spaced by an angular gap alpha (α). The angular gap alpha is <=20°, preferably <=10°, preferably <=5°.

The indicia are able to emit light, which is preferably homogenous. Obviously, the viewing position is from the front side of the panel.

The visibility of the sign from the front side, is given when the sign is “on” state, meaning that at least one of the indicia is emitting light. The visibility can additionally be given by a difference in material appearance between the indicia's means front side and the panel's board.

The terms front side and back side have the common meaning in the art. The front side of the panel is the side which is configured to be seen by a user, it is also the side towards which most of the light is emitted outwards by the indicia. The back side, which can also be named inner side, is preferably the side which is turned towards the inside of the device.

The sign has 3 indicia means, which occupy the area between two concentric circles having different radius. In other words, they are ring segments. The radius difference is preferably greater than 2 mm and smaller than 10 mm, preferably greater or equal to 3 mm and smaller or equal than 5 mm.

The space between the segments forming the indicia are called gaps. In total the sign has 3 gaps of equal angular length alpha. Thus, each two adjacent indicia means are spaced, i.e. separated from each other by an angular gap alpha. The angle is 0°<=alpha is <=20°, preferably 2°<=alpha<=15°, further preferably 5°<=alpha<=15°. The relatively small angular gap has the advantage of keeping the overall circular impression of the ring. The gap is preferably greater than 0°, so that a sharp contrast corner can be achieved between the adjacent indicia.

The sharp contrast can be given by keeping the panel's board opaque at least in the gap area. The cross talking can further be avoided by having opaque walls a light blockers between the adjacent indicia (in the gap area) on the back side of the panel.

The sign preferably comprises a light source associated to each of the indicia means. Preferably, each light source comprises at least one LED. Further preferred is that each light source comprises at least one bicolor or tricolor LED. The term LED is to be interpreted broadly, as a semiconductor element able to emit light upon electrical excitation coming from an electronic circuit. Preferred examples are inorganic light emitting diode, organic light emitting diode, and light emitting transistor.

The information is transmitted to the user via color, intensity, or a combination thereof. A time related change of these characteristics can also be used to display information, for instance a changing pattern, such as left or right rotation.

In one preferred embodiment of the invention, each light source comprises a transparent component with refraction index greater than the refraction index of the air, wherein the transparent component is configured so that the emitted light from the associated LED(s) creates a homogenous image of the annular segment when the LED is emitting light. Such transparent component has preferably a refractive index between 1.3 and 1.5. Preferably, the transparent component is colorless. One example is acrylic, which can be injection molded into the require shape so that it guides the light from the LED to the front side with minimum losses.

It is preferred that the light sources and/or the gap are configured such that the gap does not emit light, also does not emit scattered light. Preferably, the gap area occupied by the panel's board and the board is opaque. Alternatively or in addition, there can be opaque walls between the light sources, on the back side of the panel to avoid cross talking. Cross talking occurs when the light from one light source can be seen on the adjacent indicia, which is not associated with that said light source.

Preferably, the there is no gap between each indicia and the panel. Preferably, the there is no gap between each annular segment and the panel occupying the gap. Preferably, all indicia are flush with the panel front side's surface, so that it appears that the annular segment is fully integrated into the panel's surface.

In one particularly preferred embodiment of the invention, the sign comprises a button, preferably in its center. Preferably, the button has a symbol and, its symbol comprises a circle when viewed from the front side. For example, a cylindrical push button has a circle when viewed from the front side (viewer is at the axial extension of the cylindrical axis). For the symbol's circle, the term circle comprises a circle that is interrupted. The circle of the symbol is preferably concentric with the two concentric circles, as explained above. Preferably, the buttons are flat; these could be push buttons, such as membrane buttons, but also proximity buttons, such as capacitive buttons. In one embodiment, the capacitive button is preferred because it has an overall longer mid time to failure due to the lack of moving parts.

The preferred buttons comprise an on/off symbol according to IEC 5010 (JTC1 003) or a stand-by symbol according to IEC 5009 (JTC1 010). The stand-by symbol is preferred. In any of both symbols, the circle, which is closed in the on/off symbol and partially interrupted in the stand-by symbol, is preferably concentric to the two concentric circles as defined above for the indicia.

The on/off symbol (IEC 5010, JTC1 003) and the stand-by symbol (IEC 5009, JTC1 010) have each a symbol circle and a straight radial line segment. In the on/off symbol, the middle of the line segment coincides with the centre of the symbol's circle, and the segment is a bit shorter than the symbol's circle diameter. In the stand-by symbol, the symbol's circle is interrupted by an arc theta, and the middle of the line segment is offset along the radius from the symbol's circle centre, further the line segment protrudes out of the symbol's circle perimeter at the middle of the arc theta.

In a particularly improved version of the invention, the line segment of the standardized on/off symbol according to IEC 5010 (JTC1 003) or of the standardized stand-by symbol according to IEC 5009 (JTC1 010) is collinear with the bisector (11) of one angular gap alpha. This line segment collinear with a radius of the centre of the two concentric circles, when the symbol's circle is concentric with the two concentric circles as defined above for the indicia. This alignment is especially relevant for devices in which the button is arranged such that the line segment is vertical or in the case wherein the stand-by button is vertical or faces away from a user. For example, if the device is such that if and/or when the panel is in a vertical, then the line segment is also in a vertical. This provides a symmetric distribution of the indicia means, facilitating the recognition of the information by a user, as will be shown in the examples.

For the stand-by symbol according to IEC 5009 (JTC1 010), it is preferred that the bisecting line of arc theta is collinear with bisecting line of angle alpha of one gap. It is further preferred that the interruption of the symbol is opposed to said gap in relation to the centre of the circles, as shown in the FIG. 1.

Collinear lines (or line segment) within the meaning of the invention, means that two or more of the referred lines (or line segments) can be described (as a part) of the same straight line.

In a further aspect of the invention an electrical emanation device, in particular for an insect repellant and/or scent, comprising a panel according to the invention is disclosed. Electrical emanation devices are often provided as an electrical plug. Thus, such devices are very small and there is not much room for buttons and/or signs. At the same time, such devices often have different operation modes and it need to be easily and clearly indicated, which mode is currently used. Thus, the panel and sign described above are particularly advantageous for an electrical emanation device, such as an insect repellant plug or a scent plug.

In another aspect of the invention, the information displayed on the inventive sign is displayed on a second sign, preferably a virtual sign shown on a computer display. Therefore, a user can get remote information in the same form as the user would get when looking at the physical sign. This is solved by a process comprising the steps of:
(i) reading data representing the state of the sign according to the claims from a first memory and storing it in a second memory
(ii) converting the second memory into a symbol on a computer display which depicts the sign and its current state
   wherein in step (i) further comprises one of:
      a. receiving the data from a device comprising the sign; or
      b. receiving the data from a server which stores the state of the sign; or
      c. receiving the data from a user input converted data.

Step (i) preferably comprises receiving the data from a remote location via a telecommunication interface. The data can be received preferably from at least one of: a server, a variable in the telecommunication interface itself, the device. The second memory is a local memory associated to the computer having the display. The term computer is to be interpreted broadly, for instance it also comprises a smartphone.

Preferably, the device comprising the sign is an electrical emanation device, in particular for an insect repellant and/or scent, as described above, as in particular emanation devices profit from the space and cost saving deign of the panel and sign described above.

The invention also comprises a software for being executed on a computer for executing the process above. The software is thus able to reproduce the state of the sign on a user's equipment display such as a smartphone.

The invention will be further explained in detail[s] by referring to the schematic figures.

### BRIEF DESCRIPTION OF THE DRAWINGS

FIG. 1 shows a panel 2 according to the invention.

FIG. 2 shows a cross sectional view of the cut A-A′ from the panel 2 from FIG. 1.

### DETAILED DESCRIPTION OF THE INVENTION

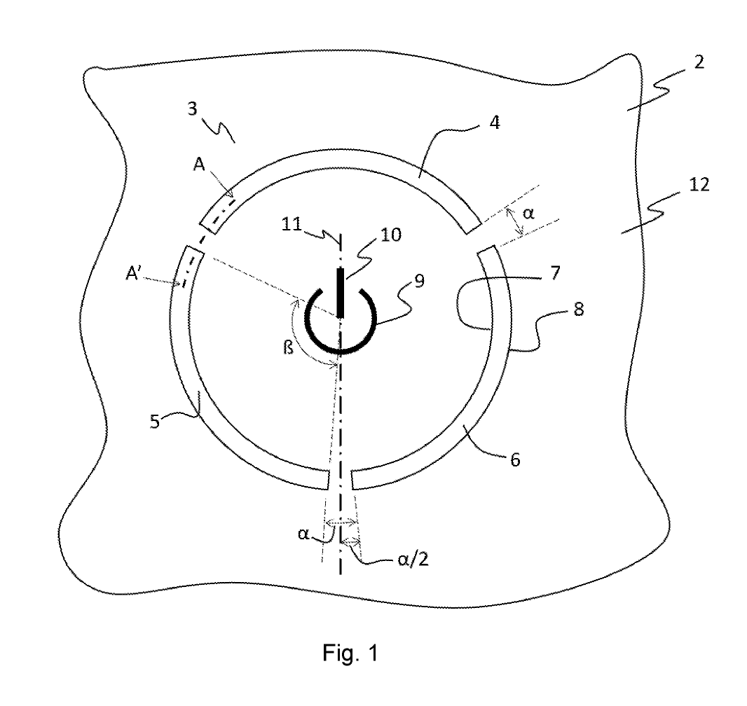

FIG. 1 shows a panel 2, represented only by a segment 2, for an electronic device, the view is from the front side 13. The panel 2 comprises a sign 3, which can be viewed from the panel's front side, at least in the “on” state. The sign 3 has an annular shape, which is the area between the concentric circles 7 and 8, of different radius. The sign has 3 indicia means 4,5,6, each being an annular segment of the annular shape, each with an angular length (B), and each two adjacent indicia means 4,5,6 are spaced by an angular gap alpha. Preferably the angle is 0°<=alpha is <=20°, preferably 2°<=alpha<=15°, further preferably 5°<=alpha<=15°. Thus, all 3 indicia means 4, 5,6, are distributed along a ring (annular shape), each of the indicia means being a segment of the ring with an equal angular length B, wherein two adjacent indicia means are separated by a separation arc alpha. The common center of the 2 concentric circles is the center for measuring the angles. It is implicit throughout the invention that 3*alpha+3*β=360°. The angles are within the conventional tolerances, which are accepted as long as they do not significantly disturb the angular symmetry.

FIG. 1 shows the preferred embodiment in which the center of the sign has button with a standard stand-by symbol, the symbol being comprised by the circle 9 and the line segment 10. The line segment 10 is collinear with gap alpha bisecting line. The bisecting line is the center line crossing the common center of all circles, bisecting the lowest gap alpha by two equal angles alpha/2. It is preferred, especially in this embodiment, that the interruption of the symbols circle 9, where the line segment 10 protrudes out is opposed to the gap alpha to which the line segment is collinear to the bisecting line. Small tolerances are allowed as long as the symbol keeps its symmetrical appearance. For the case with the standard power button which does not have the interruption in the circle, it is preferred that the line segment of the symbol is collinear with the bisecting line of gap alpha, analog as just described for the stand-by button. With this arrangement of symbol and indicia and gap, the user has a reference given especially by the combination of the line segment and the gap, dividing the symbol into a right and left side. The right side has the indicia 6, the left side has the indicia 5. There is clearly an upper side, namely the indicia 4. A lower side can be formed by simultaneously activating (emitting light with same characteristics) of indicia 5 and 6. Thus, with this arrangement a complete set of information for 4 directions can be displayed by the sign although only 3 indicia are used.

It is preferred that the sign comprises light sources 14, 15, 16 respectively associated to the indicia means 4, 5, 6. Preferably each light source 14, 15, 16 comprises at least one bicolor or tricolor LED. SMD LEDs are preferred, thus flat panels can be produced which are not deep saving therefore space in the device.

In one embodiment of the invention, each light source 14, 15, 16 comprises a transparent component with refraction index greater than the refraction index of the air, wherein the transparent component is configured so that the emitted light from the associated LED(s) creates a homogenous image of the annular segment when the LED is emitting light. This transparent component works as a light guide. Preferably, the scattering of the light out of the intended indicia front side is kept to a minimum, for efficiency purposes and to avoid cross talking of light between two adjacent indicia.

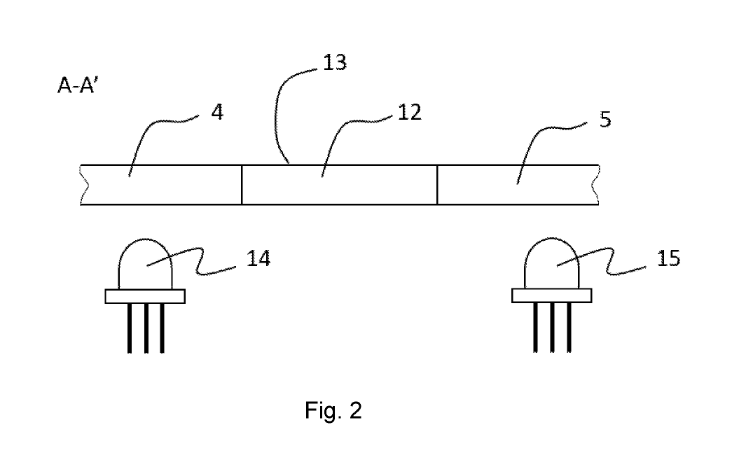

As shown in detail in FIG. 2, it is preferred that each annular segment (4 and 5 are partially shown) is flush with the panel front side's surface (13). One way of providing this is keeping the panel's board 12 filling the gap between the indicia.

What is claimed is:

1. A panel for an electronic device, with a front side, and a back side, the panel comprising a sign, suitable to be viewed from the panel's front side, wherein
the sign has a an annular shape,
characterized in that
the sign has 3 indicia means able to emit light,
each being an annular segment of the annular shape, each with an angular length,
and wherein
each two adjacent indicia means are spaced by an angular gap alpha, and wherein 0°<=alpha is <=20°.

2. The panel according to claim 1, further comprising a light source associated to each of the indicia means.

3. The panel according to claim 2, wherein each light source comprises at least one bicolor or tricolor LED.

4. The panel according to claim 3, wherein each light source comprises a transparent component with refraction index greater than the refraction index of the air, wherein the transparent component is configured so that the emitted light from the associated LED(s) creates a homogenous image of the annular segment when the LED is emitting light.

5. The panel according to claim 1, wherein each annular segment is flush with the panel front side's surface.

6. The panel according to claim 1, wherein the 3 indicia means occupy the area between two concentric circles having different radius, the panel further comprising a button concentric with the two concentric circles.

7. The panel according to claim 6, wherein the button's symbol is an on/off symbol or a stand-by symbol.

8. The panel according to claim 7, wherein the standardized line segment of the on/off symbol or the stand-by symbol is colinear with a radius of the centre of the two concentric circles which radius is also the bisector of one angular gap alpha.

9. An electrical emanation device comprising a panel according to claim 1.

10. A process comprising the steps of:
(i) reading data representing the state of the sign according to claim 1 from a first memory and storing it in a second memory
(ii) converting the second memory into a symbol on a computer display which depicts the sign and its current state
wherein in step (i) further comprises one of:
a. receiving the data from a device comprising the sign; or
b. receiving the data from a server which stores the state of the sign; or
c. receiving the data from a user input converted data.

11. The process according to claim 10, wherein the device comprising the sign is an electrical emanation device.

12. A computer program code, the computer program code when executed by a computer causing the computer to perform the steps of the process of claim 10.
